(19) United States
(12) Patent Application Publication
(10) Pub. No.: US 2020/0057284 A1
(43) Pub. Date: Feb. 20, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/530,977

(22) Filed: Aug. 2, 2019

(30) Foreign Application Priority Data
Aug. 15, 2018 (CN) 201821313360.7

(51) Int. Cl. G02B 15/17; G02B 13/00; G03B 11/04

(52) U.S. Cl. CPC G02B 15/17; G03B 11/045; G02B 13/0015

(57) ABSTRACT

Provided is a lens module, including a lens barrel; and a set of lenses received in the lens barrel. The set of lenses at least includes first and second lenses. The first and second lenses cooperate with each other in a direction from an object side to an image side. A surface of the first lens facing towards the second lens includes a first abutting surface extending horizontally toward an optical axis, and a first oblique surface extending obliquely from the first abutting surface in a direction facing towards the optical axis and towards the object side. The second lens includes a second abutting surface attached to the first abutting surface, and a second oblique surface extending obliquely from the second abutting surface in the direction facing towards the optical axis and towards the object side. The first oblique surface is spaced apart from the second oblique surface.

### TECHNICAL FIELD

The present disclosure relates to the field of camera lenses, and in particular, to a lens module.

### BACKGROUND

With the continuous development of technology, electronic devices become more and more intelligent. In addition to digital cameras, portable electronic devices such as tablet PC and mobile phones are also equipped with lens modules. In order to meet the people's use requirements, the higher demands have been proposed on imaging quality of the lens module.

In the related art, a light shading sheet in a lens module is sandwiched between two adjacent lenses in order to provide a shading effect for the lens. However, the light shading sheet is an annular structure formed by punching into two concentric circles, which is a single form. A portion of the light shading sheet abutting against the light shading sheet cannot interfere with the light shading sheet. As a result, the light shading sheet has a poor shading effect and stray light may even exist, thereby affecting an optical performance of the lens module.

Therefore, it is necessary to provide a new lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional structural schematic view of a lens module according to Embodiment 1 of the present disclosure;

FIG. 2 is a cross-sectional structural schematic view of a first lens of the lens module according to Embodiment 1 of the present disclosure;

FIG. 3 is a structural schematic view of a second lens of the lens module according to Embodiment 1 of the present disclosure;

FIG. 4 is a cross-sectional structural schematic view of a lens module according to Embodiment 2 of the present disclosure;

FIG. 5 is a cross-sectional structural schematic view of a first lens of the lens module according to Embodiment 2 of the present disclosure; and

FIG. 6 is a cross-sectional structural schematic view of a second lens of the lens module according to Embodiment 2 of the present disclosure.

### DESCRIPTION OF EMBODIMENTS

The present disclosure will be further illustrated with reference to the accompanying drawings and the embodiments.

### Embodiment 1

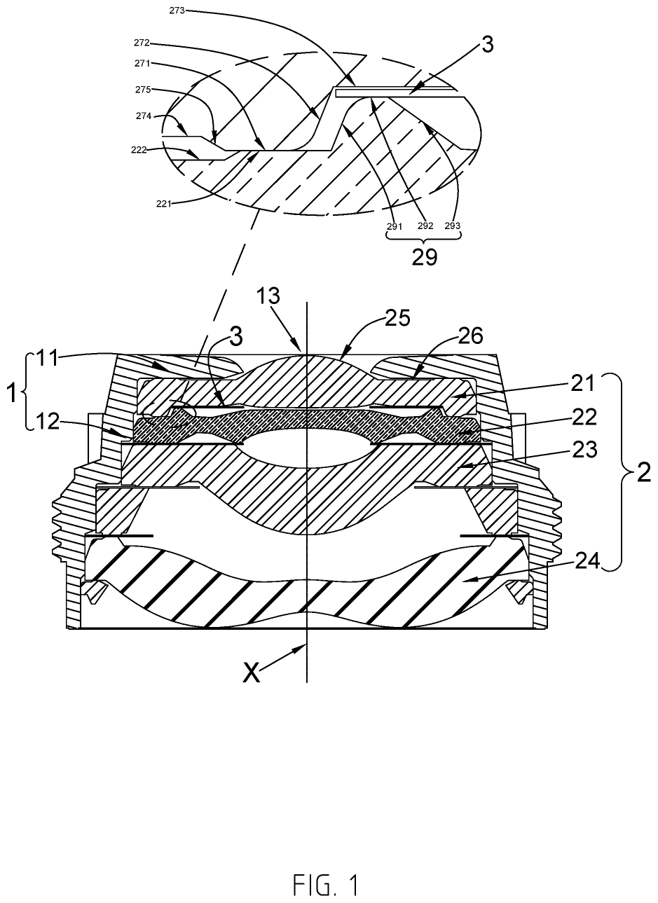

As shown in FIG. 1, the present disclosure provides a lens module. The lens module includes a lens barrel 1 and a set of lenses 2 received in the lens barrel 1. The set of lenses 2 at least includes two lenses. In this embodiment, the set of lenses 2 includes a first lens 21, a second lens 22, a third lens 23 and a fourth lens 24 that cooperate with each other in a direction from an object side to an image side, but it is not limited thereto. The number of the lenses may be determined according to actual requirements.

The lens barrel 1 includes a light through hole 13. The lens barrel 1 has a first barrel wall 11 extending horizontally and a second barrel wall 12 extending vertically from a first barrel wall 11 while being bent downwardly, which may be formed into one piece or a fission structure.

In this embodiment, the lens module further includes a light shading member 3 sandwiched between the lenses. The light shading member 3 is optionally a light shading sheet, but may also be a light shading plate.

In order to increase a gate depth and an edge thickness while improving the design freedom, a cooperating structure of the first lens 21 and the second lens 22 is improved, and the specific scheme is as follows.

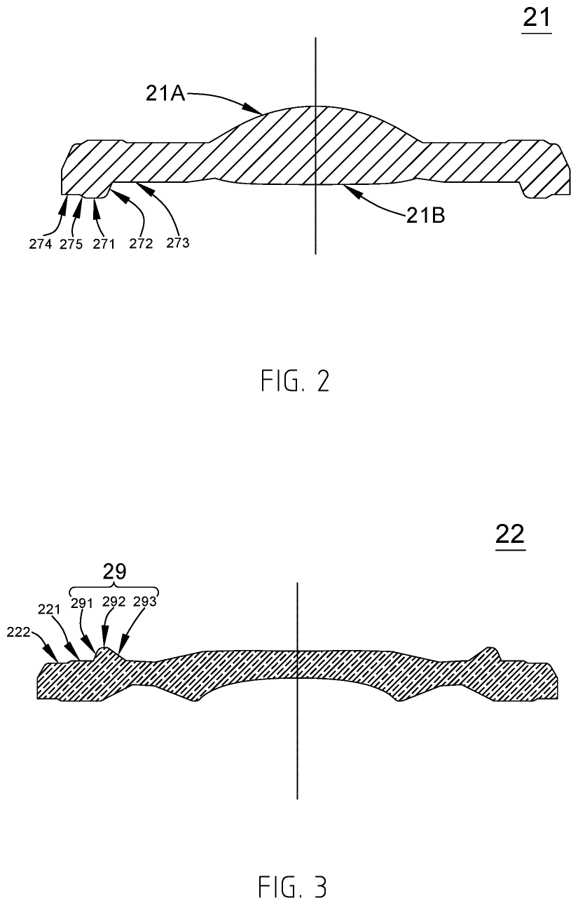

As shown in FIGS. 1 and 2, each lens in the set of lenses 2 has an axisymmetric structure, and includes an optical portion 25 and a peripheral portion 26 surrounding the optical portion 25. In an example, the first lens 21 has an axisymmetric structure. The upper surface of the first lens 21 is a first surface 21A, and the lower surface of the first lens 21 is a second surface 21B. The surface (i.e., the second surface 21B) of the first lens 21 cooperating with the second lens 22 includes a first abutting surface 271 extending horizontally towards an optical axis X, a first oblique surface 272 extending obliquely from the first abutting surface 271 along a direction facing towards an optical axis X and towards the object side, and a first planar surface 273 extending horizontally from the first oblique surface 272 towards the optical axis X. The first abutting surface 271 is spaced apart from an outer edge of the first lens 21. The first oblique surface 272 may be connected to the first abutting surface 271 and the first planar surface 273 via an arc surface, or may be directly connected to the first abutting surface 271 and the first planar surface 273 at an angle. The first lens 21 has a greater thickness at the first abutting surface 271 than at the first planar surface 273. In addition, a second surface 21B of the first lens 21 further includes a seventh planar surface 274 extending horizontally from the outer edge of the first lens 21 towards the optical axis X, and a fifth oblique surface 275 extending obliquely from the seventh planar surface 274 in a direction facing towards the optical axis X and towards the image side. The fifth oblique surface 275 is connected to the first abutting surface 271.

As shown in FIGS. 1 and 3, the second lens 22 is provided with a second abutting surface 221 attached to the first abutting surface 271, and a first protruding portion 29 connected to the second abutting surface 221. The protruding portion 29 includes a second oblique surface 291 extending obliquely from the second abutting surface 221 in a direction facing towards the optical axis X and towards the object side, a second planar surface 292 extending horizontally from the second oblique surface 291 towards the optical axis X, and a seventh oblique surface 293 extending obliquely from the second oblique surface 292 in a direction facing towards the optical axis X and towards the image side. The first oblique surface 272 is spaced apart from the second oblique surface 291. Further, a slope of the first oblique surface 272 may be equal or unequal to that of the second oblique surface 292. A light shading sheet 3 is sandwiched between the first planar surface 273 and the second planar surface 223. The light shading sheet 3 is closer to the optical axis X than the first abutting surface 271.

In an example, the second lens 22 further includes a recessed portion 222 connected to the second abutting surface 221. The recessed portion 222 is closer to a side of the inner wall surface of the lens barrel 1 than the second abutting surface 221, and is further closer to the lower surface of the second lens 22 than the second abutting surface 221. In other words, the second lens 22 has a smaller thickness at the recessed portion 222 than at the second abutting surface 221.

Therefore, a concave-convex fitting structure is formed between the first lens 21 and the second lens 22, so that the gate depth and the edge thickness can be increased, and the design freedom can be improved.

In addition, the first lens 21, the second lens 22 and the third lens 23 are, for example, glass lenses, plastic lenses, or lenses of other materials. Further, the light shading member 3 may be provided between the lenses. The light shading member 3 may be a light shading sheet or a light shading plate, which can be determined according to actual requirements. In this embodiment, a light shading sheet is preferable.

### Embodiment 2

In this embodiment, descriptions for same parts as those of Embodiment 1 will be omitted.

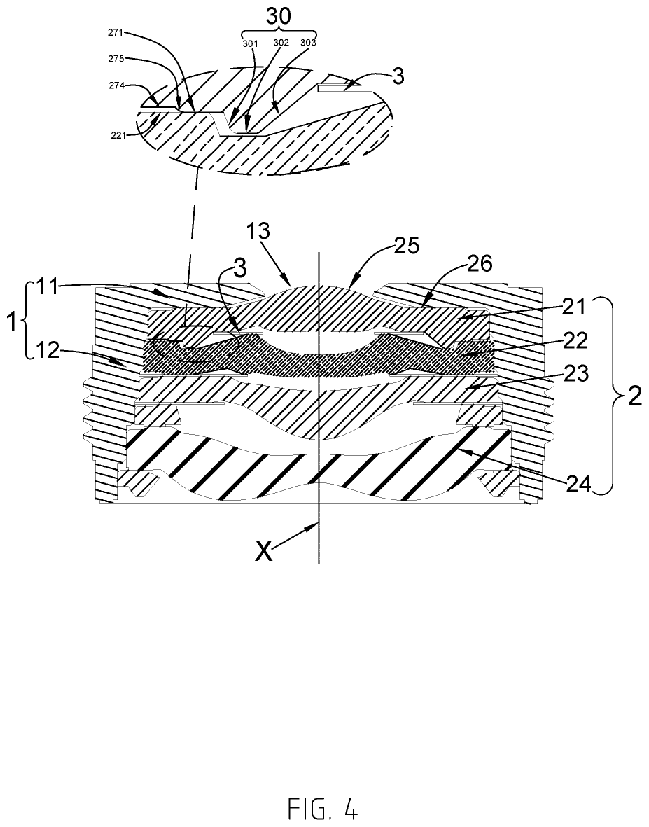

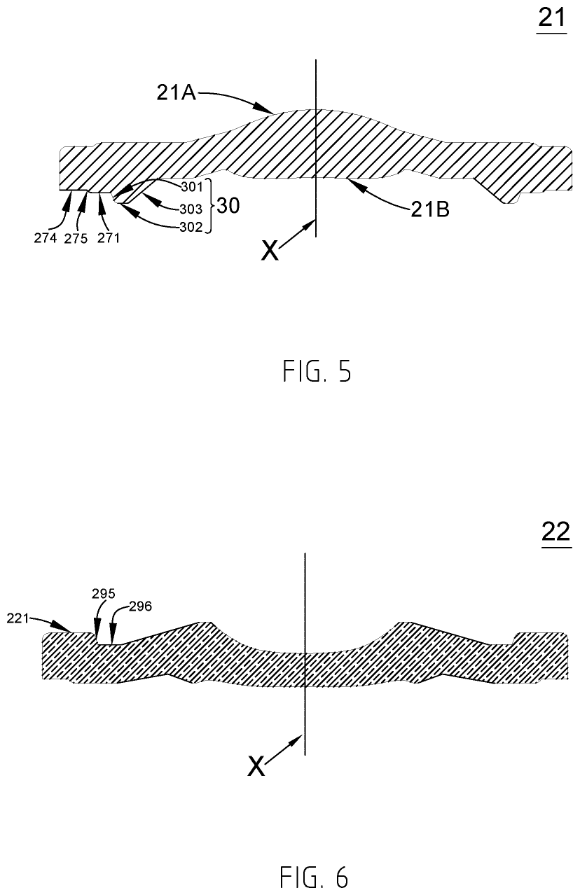

As shown in FIGS. 4 and 5, an upper surface of the first lens 21 is a first surface 21A, and a lower surface of the first lens 21 is a second surface 21B. A surface (the second surface 21B) of the first lens 21 cooperating with the second lens 22 includes a first abutting surface 271, and a second protruding portion 30 connected to the first abutting surface 271 and protruding towards the second lens 22. The second protruding portion 30 includes a third oblique surface 301 extending obliquely from the first abutting surface 271 in a direction facing towards the optical axis X and towards the image side, a third planar surface 302 extending horizontally from the third oblique surface 301 towards the optical axis X, and an eighth oblique surface 303 extending from the third planar surface 302 in a direction facing towards the optical axis X and towards the object side. In addition, the second surface 21B of the first lens 21 further includes a structure connected to the first abutting surface 271 and located at a side of the first abutting surface 271 close to the inner wall surface of the lens barrel 1. The structure is the same as that of Embodiment 1, which will not be elaborated herein.

As shown in FIGS. 4 and 6, the second lens 22 is provided with a second abutting surface 221 attached to the first abutting surface 271, a fourth oblique surface 295 extending obliquely from the second abutting surface 221 in a direction towards the optical axis X and towards the image side, and a fourth planar surface 296 extending horizontally from the fourth oblique surface 295 towards the optical axis X. The third oblique surface 301 is spaced apart from the fourth oblique surface 295. The third planar surface 302 is spaced apart from the fourth planar surface 296. The light shading member 3 is closer to the optical axis X than the second protruding portion 30. In this embodiment, there is no recessed portion provided at a side of the second abutting surface 221 facing away from the optical axis X. In addition, the first abutting surface 271 partially abuts against a first portion of the second abutting surface 221. There is a gap between the portion other than the first portion of the second abutting surface 221 and the second surface 21B of the first lens 21.

With the above structure, a concave-convex fitting structure is formed between the first lens 21 and the second lens 22. The light-shielding member 3 is sandwiched in a gap formed by the concave-convex fitting structure, and then is attached with only one surface (the first abutting surface 271 partially abuts against the second abutting surface), which can achieve the fitting between the first lens 21 and the second lens 22. This can increase the gate depth and the edge thickness, improve the design freedom and reduce the outer diameter of the light shading member 3.

Compared with the related art, the lens module provided by the present disclosure can increase the gate depth and the edge thickness, improve the design freedom, and reduce the outer diameter of the light shading piece.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A lens module, comprising:
a lens barrel; and
a set of lenses received in the lens barrel, the set of lenses at least comprising a first lens and a second lens, the first lens and the second lens cooperating with each other in a direction from an object side to an image side,
wherein a surface of the first lens facing towards the second lens comprises a first abutting surface extending horizontally toward an optical axis, and a first oblique surface extending obliquely from the first abutting surface in a direction facing towards the optical axis and towards the object side; the second lens comprises a second abutting surface attached to the first abutting surface, and a second oblique surface extending obliquely from the second abutting surface in the direction facing towards the optical axis and towards the object side; and the first oblique surface is spaced apart from the second oblique surface.

2. The lens module as described in claim 1, wherein the first abutting surface is spaced apart from an outer edge of the first lens.

3. The lens module as described in claim 2, wherein the first lens further comprises a first planar surface extending horizontally from the first oblique surface towards the optical axis.

4. The lens module as described in claim 3, wherein the second lens comprises a second planar surface extending horizontally from the second oblique surface towards the optical axis; and a light shading member is sandwiched between the first planar surface and the second planar surface.

5. A lens module, comprising:
a lens barrel; and
a set of lenses received in the lens barrel, the set of lenses at least comprising a first lens and a second lens, the first lens and the second lens cooperating with each other in a direction from an object side to an image side,
wherein a surface of the first lens facing towards to the second lens comprises a first abutting surface extending horizontally towards an optical axis, and a third oblique surface extending obliquely from the first abutting surface in a direction facing towards the optical axis and towards the image side; the second lens comprises a second abutting surface attached to the first abutting surface, and a fourth oblique surface extending obliquely from the second abutting surface in the direction facing towards the optical axis and towards the image side;
and the third oblique surface is spaced apart from the fourth oblique surface.

6. The lens module as described in claim 5, wherein the first abutting surface is spaced apart from an outer edge of the first lens.

7. The lens module as described in claim 6, wherein the first lens further comprises a third planar surface extending horizontally from the third oblique surface towards the optical axis.

8. The lens module as described in claim 7, wherein the second lens comprises a fourth planar surface extending horizontally from the fourth oblique surface towards the optical axis, and the third planar surface is spaced apart from the fourth planar surface.
